(19) United States
(12) Patent Application Publication
(10) Pub. No.: US 2006/0207721 A1
(43) Pub. Date: Sep. 21, 2006

(54) Polymer adhesive splicing of water-soluble, orally ingestible thin film webs

(76) Inventors: Greg Slominski, Elmwood, NE (US); Christopher E. Fankhauser, Eagle, NE (US)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 11/083,162

(22) Filed: Mar. 17, 2005

(51) Int. Cl. B31F 5/00; B32B 37/00; B32B 37/12

(52) U.S. Cl. 156/326; 156/292; 156/157; 156/308.2; 156/308.4; 156/308.6

(57) ABSTRACT

A method is provided to splice and/or repair films. The method comprises: a) applying a splicing composition to a first water-soluble, orally-ingestible film, a second water-soluble, orally-ingestible film or to both films; b) overlapping the first water-soluble, orally-ingestible film on the second water-soluble, orally-ingestible film to form a splice between the first water-soluble, orally-ingestible film and the second water-soluble, orally-ingestible film; and c) allowing the splice to dry or cure, wherein the splicing composition comprises at least one animal-consumable solvent and, optionally, at least one orally-ingestible polymer.

### BACKGROUND OF THE INVENTION

Water-soluble thin films are being used as a carrier to deliver different materials to the human body or to animals. The thin films are dissolvable when they contact a water source releasing active ingredients contained therein. For example, the films can dissolve in the mouth when ingested. Examples of thin films can be found in U.S. Pat. No. 4,136,162 to Fuchs et al. and U.S. Pat. No. Re. 33,093 to Schiraldi et al.

The films are formed and are processed for packaging or rolled for storage. During the packaging of these films, a roll of film is run through a machine that cuts the film into desirable shapes and sizes to be packaged. Within rolls and between rolls of film, the film web must occasionally be spliced together to keep a continuous feed to the machine. If there is a break or defect in the film, the film is spliced back together.

In one method, an adhesive tape is used to splice the films together. The adhesive tape must be food grade and the adhesive chemistries have to be Generally Regarded as Safe (GRAS) as they are in direct contact with film drug product. It is most desirable to avoid adding new chemistries into contact with the drug product to avoid compatibility issues. Also, when a tape is used, the tape must stick to the product through the bulk product's shelf-life and have sufficient adhesion to maintain the web continuity even after the liner backing is removed. The tape must cause minimal interference with the converting and packaging machine process.

There are a limited number of food grade tapes available. Some tapes may not stick to films that are more hydrophobic. Also, the adhesive tape can fail to maintain a good bond with the product. A failure of the splice results in downtime to re-splice the film. Also, tape from a splice can stick to the cutting components of the converting machine. Additionally, it is not intended for the tape to be packaged with the film. Pieces that contain the tape are removed before packaging. This requires intervention to ensure that the tape is not packaged.

It would be desirable to be able to splice these films together without the need for an additional solid material to hold the films together.

### SUMMARY OF THE INVENTION

The present invention relates to a method comprising:
a) applying a splicing composition to a first water-soluble, orally-ingestible film, a second water-soluble, orally-ingestible film or to both films;
b) overlapping the first water-soluble, orally-ingestible film on the second water-soluble, orally-ingestible film to form a splice between the first water-soluble, orally-ingestible film and the second water-soluble, orally-ingestible film; and
c) allowing the splice to dry or cure,
   wherein the splicing composition comprises at least one animal-consumable solvent and, optionally, at least one orally-ingestible polymer.

### DETAILED DESCRIPTION

As used throughout, ranges are used as a shorthand for describing each and every value that is within the range. Any value within the range can be selected as the terminus of the range. When used, the phrase “at least one of” refers to the selection of any one member individually or any combination of the members. The conjunction “and” or “or” can be used in the list of members, but the “at least one of” phrase is the controlling language. For example, at least one of A, B and C is shorthand for A alone; B alone; C alone; A and B; B and C; A and C; or A and B and C.

A method is provided to splice and/or repair films. The splice can be between two separate films, or the splice can be between different parts of the same film (a repair). The method comprises:
a) applying a splicing composition to a first water-soluble, orally-ingestible film, a second water-soluble, orally-ingestible film or to both films;
b) overlapping the first water-soluble, orally-ingestible film on the second water-soluble, orally-ingestible film to form a splice between the first water-soluble, orally-ingestible film and the second water-soluble, orally-ingestible film; and
c) allowing the splice to dry or cure,
   wherein the splicing composition comprises at least one animal-consumable solvent and, optionally, at least one orally-ingestible polymer. The method can provide a splice without the use of an adhesive tape.

The first water-soluble, orally-ingestible film and the second water-soluble, orally-ingestible film can be separate films, or they can be different parts of the same film. Examples of films include, but are not limited to, the water-soluble, orally-ingestible films described in U.S. Pat. No. 4,136,162 to Fuchs et al. and U.S. Pat. No. RE33,093 to Schiraldi et al.

The animal-consumable solvent can be any solvent that is consumable by an animal. One type of animal of interest is a human. Examples of the animal-consumable solvent include, but are not limited to, water, ethanol, acetone, 1-propanol, 2-propanol and combinations thereof. In one embodiment, the solvent is water, and in another embodiment, the solvent is a mixture of water and ethanol. In one embodiment of the water and ethanol mixture, the amount of water in the total amount of solvent ranges from 10-90% by weight of the solvent.

The orally-ingestible polymer can be any water-soluble, film-forming polymer that can be used in a orally-ingestible composition. Examples of the orally-ingestible polymer include, but are not limited to, hydroxypropyl cellulose, hypromellose, hydroxypropyl methyl cellulose, polyvinyl alcohol, hydroxyl ethyl cellulose, pullulan, polyvinyl pyrrolidone, carboxymethyl cellulose, sodium alginate, polyethylene glycol, xanthan gum tragancanth gum, guar gum, acacia gum, arabic gum, starch, gelatin, polyacrylic acid, methylmethacrylate copolymer, carboxyvinyl copolymers, ethyl cellulose, hydroxypropyl ethyl cellulose, cellulose acetate phthalate, hydroxypropyl methyl cellulose phthalate, poly(glycolic acid), poly(lactic acid), polydioxanoes, polyoxalates and mixtures and copolymers thereof. Additional useful polymers include, stereopolymers of L- and D-lactic acid, copolymers of bis(p-carboxyphenoxy) propane acid and sebacic acid, sebacic acid copolymers, copolymers of caprolactone, poly(lactic acid)/poly(glycolic acid)/polyethyleneglycol copolymers, copolymers of polyurethane and poly(lactic acid), copolymers of polyurethane and poly(lactic acid), copolymers of α-amino acids, copolymers of α-amino acids and caproic acid, copolymers of α-benzyl glutamate and polyethylene glycol, copolymers of succinate and poly(glycols), polyphosphazene, polyhydroxy-alkanoates, a lactide/glycolide co-polymer and/or polyanhydrides.

When present, the orally-ingestible polymer is present in the splicing composition in an amount from greater than 0-30% by weight of the splicing composition. When a film is solvent-soluble, at least a portion of the film will soften or become tacky, and this portion of the film may be used as the adhesive.

The splicing composition can be applied to a water-soluble, orally-ingestible film in any amount such that water-soluble, orally-ingestible film is not completely dissolved and the film retains physical integrity when the splicing composition is applied. In one embodiment, the splicing composition is applied to a water-soluble, orally-ingestible film in an amount from 10-80% by weight of the film area to which the splicing composition is applied (wt./wt.).

The splicing composition can be applied by any method. Methods include, but are not limited to, wiping, spraying, brushing or rolling.

The amount of overlap of one film over the other film can be any amount that provides for a desired strength to the splice. In one embodiment, the amount of overlap is from 10-50 mm.

After the overlap is formed, the splice is dried and/or cured. Drying/curing of the splice can occur at any temperature that allows the splice to dry/cure without thermal degradation or melting the water-soluble, orally-ingestible film. For example, this can be done at ambient room temperature. Temperatures above room temperature can be used to accelerate the drying/curing process. Any temperature less than the thermal degradation or melting temperature of the film can be used. In one embodiment, the temperature can be from room temperature up to 80° C.

It is possible for a joint formed by the splicing method to have a tensile strength that is greater than the tensile strength of the neat film.

### SPECIFIC EMBODIMENTS OF THE INVENTION

The invention is further described in the following examples. The examples are merely illustrative and do not in any way limit the scope of the invention as described and claimed.

### Example 1

A polymer solution 10% by weight of hydroxypropylcellulose (Klucel JF) was prepared in a hydro-alcoholic solvent by combining 20 g of ethanol, 70 g of purified water and dissolving in 10 g of Klucel JF (a small quantitiy of FD&C blue #1, ˜10 mg, was added to color the solution to facilitate application and provide for detection of the splice by a vision system).

A splice in the web of a thin-film product was then constructed as follows. The film product consisted primarily of hydroxypropyl methyl cellulose (HPMC) and hydroxypropyl cellulose (HPC) film formers and simethicone as an API.

The film web was cut at a 90 degree angle and the film was peeled back from the liner on one side. 2.54 cm (one inch) of liner was removed from that side to create the 2.54 cm (one inch) overlap-splice of the film product. The liner was butt-spliced together with tape and then the polymer adhesive prepared above was thinly brushed very gently over front of the bottom layer of film. Then the 2.54 cm (one inch) of peeled back top film was pressed against the wetted bottom layer. A tissue and hand pressure were used to press out the wrinkles on the combined films. The splice was allowed to cure at room temperature.

### Example 2 (Prophetic)

A solution 50% by weight of ethanol in water can be prepared by mixing 50 g of purified water and 50 g of ethanol.

A splice in the web of a thin film product can be constructed as follows. The film product may consist primarily of HPMC and HPC film-formers and dextromethorphan as a cough suppressant.

The film web is cut at a 90 degree angle and the film is peeled back from the liner on one side. 2.54 cm (one inch) of liner is removed from that side to create the 2.54 cm (one inch) overlap-splice of the film product. The liner is butt-spliced together with tape and then the solvent adhesive prepared above is thinly brushed very gently over the front of the bottom layer of film. Then the 2.54 cm (one inch) of peeled back top film is pressed against the wetted bottom layer. A tissue and hand pressure are used to press out the wrinkles on the combined films. The splice is allowed to cure at room temperature.

It should be appreciated that the present invention is not limited to the specific embodiments described above, but includes variations, modifications and equivalent embodiments defined by the following claims.

What is claimed is:

1. A method comprising:
a) applying a splicing composition to a first water-soluble, orally-ingestible film, a second water-soluble, orally-ingestible film or to both films;
b) overlapping the first film on the second film to form a splice between the first film and the second film; and
c) allowing the splice to dry or cure,
wherein the splicing composition comprises at least one animal-consumable solvent and, optionally, at least one orally-ingestible polymer.

2. The method of claim 1, wherein the first water-soluble, orally-ingestible film is on a first roll and the second water-soluble, orally-ingestible film is on a second roll.

3. The method of claim 1, wherein the first water-soluble, orally-ingestible film and the water-soluble, orally-ingestible second film are parts of the same film.

4. The method of claim 1, wherein no tape is used to form the splice.

5. The method of claim 1, wherein the at least one orally-ingestible polymer is present in the splicing composition.

6. The method of claim 1, wherein the at least one orally-ingestible polymer is present in the splicing composition in an amount from greater than 0-30% by weight of the splicing composition.

7. The method of claim 1, wherein the at least one animal-consumable solvent is at least one of water, ethanol, acetone, 1-propanol and/or 2-propanol.

8. The method of claim 5, wherein the at least one orally-ingestible polymer is at least one of hydroxypropyl cellulose, hypromellose, hydroxypropyl methyl cellulose, polyvinyl alcohol, hydroxyl ethyl cellulose, pullulan, polyvinyl pyrrolidone, carboxymethyl cellulose, sodium alginate, polyethylene glycol, xanthan gum tragancanth gum, guar gum, acacia gum, arabic gum, starch, gelatin, polyacrylic acid, methylmethacrylate copolymer, carboxyvinyl copolymers, ethyl cellulose, hydroxypropyl ethyl cellulose, cellulose acetate phthalate, hydroxypropyl methyl cellulose phthalate, poly(glycolic acid), poly(lactic acid), polydioxanoes, polyoxalates, poly(α-esters), polyanhydrides, polyacetates, polycaprolactones, poly(orthoesters), polyamino acids, polyaminocarbonates, polyurethanes, polycarbonates, polyamides, poly(alkyl cyanoacrylates), stereopolymers of L- and D-lactic acid, copolymers of bis(p-carboxyphenoxy) propane acid and sebacic acid, sebacic acid copolymers, copolymers of caprolactone, poly(lactic acid)/poly(glycolic acid)/polyethyleneglycol copolymers, copolymers of polyurethane and poly(lactic acid), copolymers of polyurethane and poly(lactic acid), copolymers of α-amino acids, copolymers of α-amino acids and caproic acid, copolymers of α-benzyl glutamate and polyethylene glycol, copolymers of succinate and poly(glycols), polyphosphazene, polyhydroxy-alkanoates, a lactide/glycolide co-polymer and/or polyanhydrides.

9. The method of claim 1, wherein the splicing composition is applied to a film in an amount from to 10-80% by weight of the film area to which the splicing composition is applied (wt./wt.)

10. The method of claim 1, wherein the animal-consumable solvent comprises water.

11. The method of claim 1, wherein the animal-consumable solvent comprises a mixture of water and ethanol.

12. The method of claim 1, wherein the animal-consumable solvent comprises a mixture of water and ethanol, wherein the water is present in the animal-consumable solvent in an amount from 10-90% by weight of water.

13. The method of claim 1, wherein the first water-soluble, orally-ingestible film overlaps the second water-soluble, orally-ingestible film in an amount from 10-50 mm.
